(19) United States
(12) Patent Application Publication
(10) Pub. No.: US 2024/0023052 A1
(43) Pub. Date: Jan. 18, 2024

(54) METHOD FOR PERFORMING POSITIONING BY USING ONE-TO-ONE TRANSMISSION BETWEEN UES IN NEXT-GENERATION MOBILE COMMUNICATION

(71) Applicant: SAMSUNG ELECTRONICS CO., LTD., Suwon-si (KR)

(72) Inventors: June HWANG, Suwon-si (KR); Hyunjeong KANG, Suwon-si (KR)

(21) Appl. No.: 18/353,740

(22) Filed: Jul. 17, 2023

(30) Foreign Application Priority Data
Jul. 15, 2022 (KR) 10-2022-0087458

(51) Int. Cl. H04W 64/00; H04L 5/00

(52) U.S. Cl. CPC H04W 64/00; H04L 5/0051; H04W 92/18

(57) ABSTRACT

The disclosure relates to a 5G or 6G communication system for supporting a higher data transmission rate. According to the disclosure, a terminal may transmit a discovery message for a sidelink positioning including a proximity services (ProSe) application code indicating the sidelink positioning, establish a link for the sidelink positioning with a second terminal, transmit, to the second terminal, a sidelink positioning assistance data including sidelink positioning reference signal (PRS) configuration information, transmit, to the second terminal, at least one PRS based on the PRS configuration information, and receive from the second terminal, a measurement result for the at least one PRS.

### CROSS-REFERENCE TO RELATED APPLICATION

This application is based on and claims priority under 35 U.S.C. 119 to Korean Patent Application No. 10-2022-0087458, filed on Jul. 15, 2022, in the Korean Intellectual Property Office, the disclosure of which is herein incorporated by reference in its entirety.

### BACKGROUND

### I. Field

The present disclosure relates to operation of a terminal in a mobile communication system. Specifically, the disclosure relates to a technology for deriving the location of a specific UJE by using communication between UEs.

### 2. DESCRIPTION OF RELATED ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 60 mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding bearnforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR LIE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IloT) for supporting new services through interworking and convergence with other industries, 1AB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in s_{y}stem architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (X) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terabertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AL (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wirless communication systems as described above, various services can be provided, and accordignly there is a need for schemes to effectively provide these services.

The above information is presented as background information only to assist with an understanding of the disclosure. No determination has been made, and no assertion is made, as to whether any of the above might be applicable as prior art with regard to the disclosure.

### SUMMARY

The disclosure relates to a transmission method and procedure necessary for positioning using device to device communication, and provides a method for transmitting a message necessary for each procedure and specific contents of the message.

In an embodiment, the present disclosure relates to a method performed by a first terminal in a sidelink communication system, the method comprising: transmitting a discovery message for a sidelink positioning including a proximity services (ProSe) application code indicating the sidelink positioning, establishing a link for the sidelink positioning with a second terminal, transmitting, to the second terminal, a sidelink positioning assistance data including sidelink positioning reference signal (PRS) configuration information, transmitting, to the second terminal, at least one PRS based on the PRS configuration information and receiving, from the second terminal, a measurement result for the at least one PRS.

In an embodiment, the present disclosure relates to a method performed by a second terminal in a sidelink communication system, the method comprising receiving a discovery message for a sidelink positioning including a proximity services (ProSe) application code indicating the sidelink positioning, establishing a link for the sidelink positioning with a first terminal, receiving, from the first terminal, a sidelink positioning assistance data including sidelink positioning reference signal (PRS) configuration information, receiving, from the first terminal, at least one PRS based on the PRS configuration informnation, mneasuring the at least one PRS, and transmitting, to the first terminal, a measurement result for the at least one PRS.

In an embodiment, the present disclosure relates to a first terminal in a sidelink communication system, the first terminal comprising a transceiver and at least one processor configured to transmit, via the transceiver, a discovery message for a sidelink positioning including a proximity services (ProSe) application code indicating the sidelink positioning, establishing a link for the sidelink positioning with a second terminal, transmit, to the second terminal via the transceiver, a sidelink positioning assistance data including sidelink positioning reference signal (PRS) configuration information, transmit, to the second terminal via the transceiver, at least one PRS based on the PRS configuration information, and receive, from the second terminal via the transceiver, a measurement result for the at least one PRS.

In an embodiment, the present disclosure relates to a second terminal in a sidelink communication system, the second terminal comprising a transceiver and at least one processor configured to receive a discovery message for a sidelink positioning including a proximity services (ProSe) application code indicating the sidelink positioning, establish a link for the sidelink positioning with a first terminal, receive, from the first terminal via the transceiver, a sidelink positioning assistance data including sidelink positioning reference signal (PRS) configuration information, receive, from the first terminal via the transceiver, at least one PRS based on the PRS configuration information, measure the at least one PRS, and transmit, to the first terminal via the transceiver, a measurement result for the at least one PRS.

According to an embodiment of the disclosure, a terminal may obtain a relative or absolute location through another UIE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a general LTE system.

FIG. 2 illustrates a radio protocol structure of a general LTE system.

FIG. 3 illustrates a structure of a next-generation mobile communication system according to an embodiment of the disclosure.

FIG. 4 illustrates a radio protocol structure of a next-generation mobile communication system according to an embodiment of the present disclosure.

FIG. 5 illustrates a block diagram for an example internal structure of a UE according to an embodiment of the disclosure.

FIG. 6 illustrates a block diagram for an example configuration of an NR base station according to an embodiment of the disclosure.

FIG. 7 illustrates a case in which a PC5-RRC layer is used as a protocol architecture according to an embodiment of the disclosure.

FIG. 8 illustrates a case in which a PC5-S layer is used as a protocol architecture according to an embodiment of the disclosure.

FIG. 9 illustrates a case in which a discovery layer is used as a protocol architecture according to an embodiment of the disclosure.

FIG. 10 illustrates a sequence diagram for an example of performing SL-P and ranging operation between UEs when a ranging request message and a response message are introduced, according to an embodiment of the disclosure

FIG. 11 illustrates a sequence diagram for an example of exchanging SL-P purpose-specific messages between UEs without a ranging request/response message after a unicast link is established, according to an embodiment of the disclosure.

### DETAILED DESCRIPTION

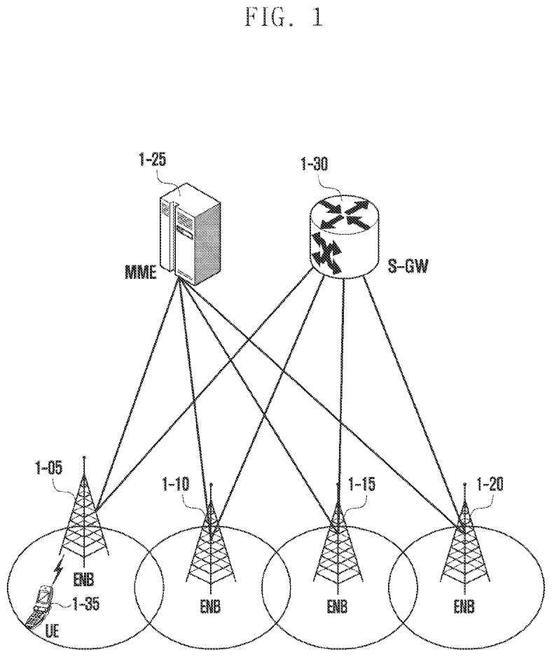

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In the following description of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Further, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5f” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or comnputer-readable memnory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the “unit” refers to a software element or a hardware element, such as a Field Programmable Gate Array (FPGA) or an Applicaion Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

In the following description, the disclosure will be described using terms and names defined in the 5GS and NR standards, which are the latest standards specified by the 3rd generation partnership project long term evolution (3GPP LTE) among the existing communication standards, for the convenience of description. However, the disclosure is not limited by these terms and names, and may be applied in the same way to systems that conform other standards. For example, the disclosure may be applied to the 3GPP 5GS/NR (5th generation mobile communication standards).

FIG. 1 is a diagram illustrating a structure of a general LTE system.

Referring to FIG. 1, the radio access network of the LTE system may include a next-generation base station (evolved node B, hereinafter referred to as ENB, node B or base station) 1-05, 1-10, 1-15, 1-20, a mobility management entity (ME) 1-25, and a serving-gateway (S-GW) 1-30. A user terminal (hereinafter referred to as UE or terminal) 1-35 may access an external network through ENBs 1-05 to 1-20 and S-GW 1-30.

In FIG. 1, the ENBs 1-05 to 1-20 may correspond to node Bs in the UMTS system of the related art. The ENB may be connected to the UE 1-35 via a radio channel and may perform a more complicated role than that of the node B of the related art. In the LTE system, since all user traffic including a real-time service such as voice over IP (VoIP) via an Internet protocol is served via a shared channel, a device collecting and scheduling status information such as buffer statuses of LEs, available transmission power status, and channel statuses may be used, and the ENBs 1-05 to 1-20 may serve as this device. One EN1B may normally control multiple cells. For example, in order to implement a transmission rate of 100 Mbps, the LTE system may use orthogonal frequency division Multiplexing (OFDM) as a radio access technology in a bandwidth of 20 MHz. Further, an adaptive modulation & coding (AMC) method for determining a modulation scheme and a channel coding rate may be applied depending on the channel status of a UE. The S-GW 1-30 is a device that provides a data bearer, and may generate or remove the data bearer tinder a control of the MME 1-25. The MME is a device in charge of not only a function of managing the mobility of the UE but also various control functions, and may be connected to a plurality of INBs.

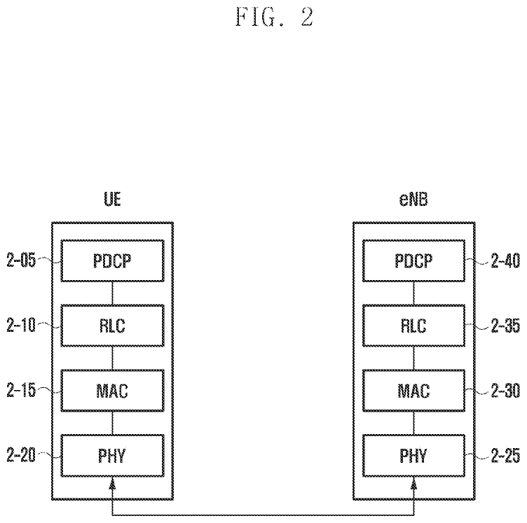

FIG. 2 illustrates a radio protocol structure of a general LTE system.

Referring to FIG. 2, the UE and ENB may include packet data convergence protocol (PDCP) 2-05, 2-40, radio link control (RiL) radio link control (RL.C) 2-10, 2-35, and medium access control (MAC) 2-15, 2-30, respectively, in radio protocols of the LTE system. The PDCP may be in charge of an operation of compressing/reconstructing an IP header. The main functions of the PDCP may be described below.
Header compression and decompression function (Header compression and decompression: robust header compression (ROHC))
User data transmission function (Transfer of user data)
Sequential delivery function (In-sequence delivery of upper layer Packet Data Units (PDUs) at PDCP reestablishment procedure for RLC acknowledged mode (AM))
Sequence re-arrangement function (For split bearers in DC (support for RLC AM): PDCP PDU routing for transmission and PDCP PDU reorderin^{g} for reception)
Duplicate detection function (Duplicate detection of lower layer service data units (SDUs) at PDCP reestablishment procedure for RLC AM)
Retransmission function (Retransmission of PDCP SDUs at handover and, for split bearers in DC, of PDCP PDUs at PDCP data recovery procedure, for RLC AM)
Ciphering and deciphering function (Ciphering and deciphering)
Timer-based SDIU removal function (Timer-based SDU discard in uplink)

The radio link control (RLC) units 2-10, 2-35 may reconfigure a PDCP packet data unit (PDU) to be the appropriate size and perform an ARQ operation. The main functions of the RLC may be summarized below.
Data transmission function (Transfer of upper layer PDUs)
ARQ function (Error Correction through ARQ (for AM data transfer))
Concatenation, segmentation, and reassembly function (Concatenation, segamentation and reassembly ofRLC SDUs (for UM and AM data transfer))
Re-segmentation function (Re-segmentation of RLC data PDUs (for AM data transfer))
Reordering function (Reordering of RLC data PDUs (for UM and AM data transfer))
Duplication detection function (Duplicate detection (for UM and AM data transfer))
Error detection function (protocol error detection (for AM data transfer))
RLC SDU deletion function (RLC SDU discard (for UM and AM data transfer))
RLC reestablishment function (RLC reestablishment)

The MACs 2-15, 2-30 may be connected to various RLC layer devices included in one UE, and perform an operation for multiplexing RLC PDUs to the MAC PD and demultiplexing the RLC PDUs from the MAC PDU. The main functions of the MAC may be summarized below.
Mapping function (Mapping between logical channels and transport channels)
Multiplexing and demultiplexing function (Multiplexing/demultiplexing of MAC SDUs belonging to one or multiple different logical channels into/from Transport Blocks (TBs) delivered to/from the physical layer on transport channels)
Scheduling information report function (Scheduling information reporting)
HARQ function (Error correction through HARQ)
Logical channel priority control function (Priority handling between logical channels of one UE)
UE priority control function (Priority handling between LEs by means of dynamic scheduling)
Multimedia broadcast multicast service (MvBMS) service identification function (tMBMS service identification)
Transport format selection function (Transport format selection)
Padding function (Padding)

The physical layer 2-20, 2-25 may perform an operation for channel-coding and modulating upper layer data to generate an OFDM symbol and transmitting the OFDM symbol via a radio channel or demodulating and channel-decoding the OFdM symbol received via a radio channel and transmitting the demodulated and channel-decoded OFDM symbol to an upper layer.

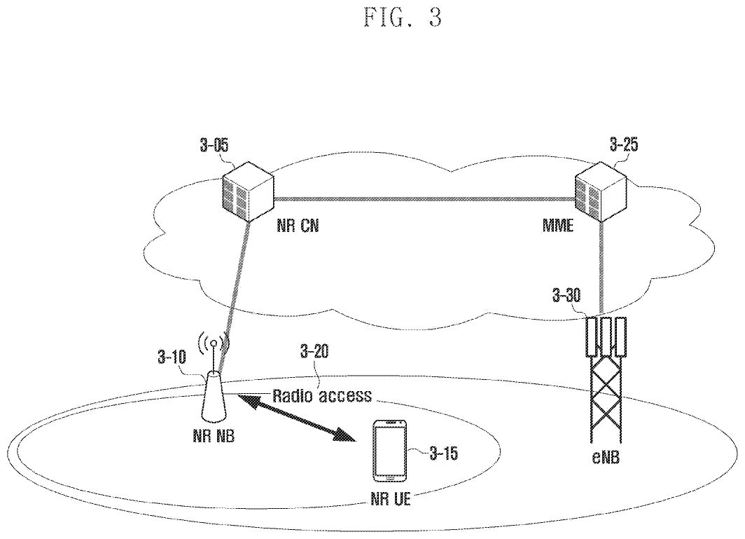

FIG. 3 illustrates a structure of a next-generation mobile communication system according to an embodiment of the disclosure.

Referring to FIG. 3, a radio access network of the next-generation mobile communication system (hereinafter NR or 5g) may include a next-generation base station (new radio node B, hereinafter NR gNB or NR base station) 3-10 and a next-generation radio core network (new radio core network, NR CN) 3-05. A next-generation radio user terminal (new radio user equipment, NR UE or terminal) 3-15 may access an external network through the NR gNB 3-10 and the NR CN 3-05.

In FIG. 3, the NR gNB 3-10 may correspond to an evolved node B (eNB) in the LTE system of the related art. The NTR gNB may be connected to the NR UE 3-15 via a radio channel and may provide better service than the node B of the related art. Since all user traffic is served through a shared channel in the next-generation mobile communication system, an apparatus for collecting and scheduling status information of buffer statuses, available transmission power statuses, and channel statuses of UEs may be used, and the NR NB 3-10 may serve the scheduling. One NR gN may control multiple cells. In the next-generation mobile communication system, a bandwidth wider than the maximum bandwidth of the related art may be applied in order to implement super-high-speed data transmission compared to LTE of the related art. In addition, beamforming technology may be further applied using orthogonal frequency division multiplexing (OFDM) via a radio access technology. Further, an adaptive modulation and coding (AM( ) scheme of determining a modulation scheme and a channel-coding rate may be applied depending on the channel status of the NR UE. The NR CN 3-05 may perform a function of supporting mobility, configuring bearer, and configuring QoS. The NR CN is a device for performing a function of managing the mobility of the NR UE and various control functions, and may be connected to a plurality of NR gNBs. In addition, the next-generation mobile communication system may be linked to the LTE system, and the NR CN may be connected to the MME 3-25 via a network interface. The MME may be connected to an eNB 3-30, which is an LTE base station.

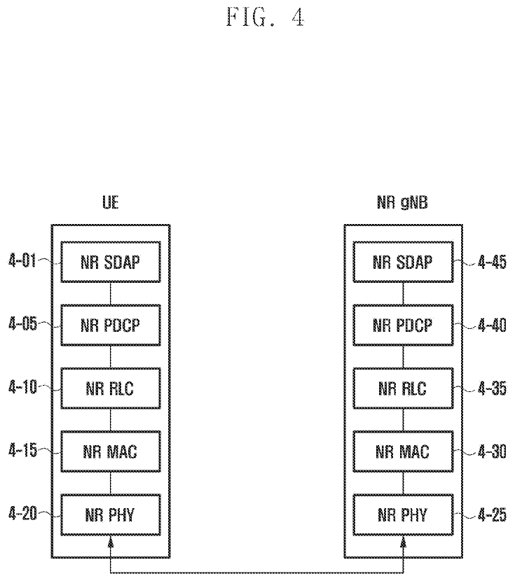

FIG. 4 illustrates a radio protocol structure of a next-generation mobile communication system according to an embodiment of the present disclosure. [00,7] Referring to FIG. 4, the JE and the NR gNB may include NR service data adaptation protocol (SDAP) 4-01, 4-45, NR PDCP 4-05, 4-40, NR RLC 4-10, 4-35, NR MAC 4-15, 4-30, and NR PHY 4-20, 4-25 in the wireless protocol of the next-generation mobile communication system.

Main functions of the NR SDAP 4-01, 4-45 may include some of the following functions.
User data transmission function (Transfer ofuser-plane data)
Function of mapping QoS flow and a data bearer for uplink and downlink (mapping between a QoS flow and a data radio bearer (DRB) for both DL and UL)
Function of marking a QoS flow ID for uplink and downlink (Marking QoS flow ID in both DL and UL packets)
Function of mapping reflective QoS flow to a data bearer for uplink SDAP PDUs (Reflective QoS flow to DRB mapping for the UL SDAP PDJs)

With respect to the SDAP layer device, the UE may receive a configuration as to whether to use a header of the SDAP layer device or a function of the SDAP layer device for each PDCP layer device, each bearer, or each logical channel through an RRC message. When the SDAP header is configured, a 1-bit indicator of non-access stratum (NAS) reflective quality of service (QoS) (NAS reflective QoS) of the SDAP header and a 1 bit-indicator of access stratum (AS) reflective quality of service (QoS) (AS reflective QoS) may indicate that the UE updates or reconfigures information on mapping of QoS flow and a data bearer in uplink and downlink. The SDAP header may include QoS flow ID information indicating the QoS. The QoS information may be used as data-processing-priority or scheduling information to support a seamless service.

Main functions of the NR PDCP 4-05, 4-40 may include some of the following finctions.
Header compression and decompression function (Header compression and decompression: ROHC)
User data transmission function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection finction (Duplicate detection of lower layer SDUs)
Retransmission function (Retransmission of PDCP SDUs)
Ciphering and deciphering function (Ciphering and deciphering)
Timer-based SDU removal function (Timer-based SDU discard in uplink)

In the description above, the reordering function of the NR PDCP device may refer to a function of sequentially reordering PDCP PDUs received by a lower layer, based on a PDCP sequence number (SN). The reordering function of the NR PDCP device may include a function of sequentially transferring the reordered data to an upper layer, or a function of directly transmitting the reordered data without considering the order, a function of recording PDCP PDUs lost due to the reordering, a function of reporting statuses of the lost PDCP PDUs to a transmitting side, and a function of making a request for retransmitting the lost PDCP PDUs.

Main functions of the NR RLCs 4-10, 4-35 may include some of the following functions.
Data transmission function (Transfer of tipper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU deletion function (RLC SDU discard)
RLC reestablishment function (RLC reestablishment)

In the description above, the sequential delivery function (In-sequence delivery) of the NR RLC device may refer to a function of sequentially transferring RLC PDUs received from a lower layer to an upper layer. The sequential delivery function (In-sequence delivery) of the NR RLC device may include, when one original RLC SDU is divided into a plurality of RLC SDUs and then received, a function of reassembling and transmitting the RLC SDUs.

The sequential delivery function (In-sequence delivery) of the NR RLC device may include a function of reordering the received REC PDUs, based on an RLC sequence number (SN) or a PDCI SN, a function of recording RLC PDUs lost due to the reordering, a function of reporting statuses of the lost RLC PDUs to a transmitting side, and a function of making a request for retransmitting the lost RLC PDUs.

The sequential delivery function (In-sequence delivery) of the NR RLC device may include, when there is a lost RLC SDU, a function of sequentially transferring RLC SDU's preceding the lost RLC SDU to the upper layer.

The sequential delivery function (In-sequence delivery) of the NR RLC device may include, if a predetermined timer expires when there is a lost RL SDU, a function of sequentially transferring all RLC SDUs received before the timer starts to the upper layer.

The sequential delivery function (In-sequence delivery) of the NR RLC device may include, if a predetermined timer expires when there is a lost RLC SDU, and a function of sequentially transferring all RLC SDUs received up to that point in time to the upper layer.

Further, the NR RLC device may process the RLC PDUs sequentially in the order of reception regardless of the sequence thereof (out-of-sequence delivery) and may transfer the RLC PDUs to the NR PDCP device.

In the case of segments, the NR RLC device may receive segments that are stored in the buffer or are to be received in the future, reconfigure the segments to be one complete RLC PDU, and then transmit the same to the PDCP device.

The NR RLC layer may not include a concatenation function, and the function may be performed by the NR MAC layer, or may be replaced with a multiplexing function of the NR MAC layer.

In the description above, the non-sequential delivery function (Out-of-sequence delivery) of the NR RLC device may refer to a function of transferrin^{g} RLC SDUs received from a lower layer directly to an upper layer regardless of the sequence of the RLC SDUTs. The non-sequential delivery function (Out-of-sequence delivery) of the NR RLC device may include, when one original RLC SI)U is divided into a plurality of RLC SDUs and then received, a function of reassembling and transmitting the RLC PDUs. The non-sequential delivery function (Out-of-sequence delivery) of the NR RLC device may include a function of storing RLC SNs or PDCP SNs of the received RLC PDUs, reordering the RLC PDUs, and recording lost RLC PDUs.

The NR MACs 4-15, 4-30 may be connected to a plurality of NR RLC layer devices configured in one UE and main functions of the NR MAC may include some of the following functions.
Mapping function (Mapping between logical channels and transport channels)
Multiplexing and demultiplexing function (Multiplexing/demultiplexing of MAC SDUs)
Scheduling information report function (Scheduling information reporting)
HARQ function (Error correction through HARQ)
Logical channel priority control function (Priority handling between logical channels of one UE)
UE priority control function (Priority handling between UEs by means of dynamic scheduling)
MBMS senvice identification function (MBMS service identification)
Transport format selection function (Transport format selection)
Padding function (padding)

The NR PHY layers 4-20, 4-25 may perform an operation of channel-coding and modulating upper layer data to generate an OFDM symbol and transnitting the OFDM symbol via a radio channel or demodulating and channel-decoding the OFDM symbol received via the radio channel and transmitting the demodulated and channel-decoded OFDM symbol to the tipper layer.

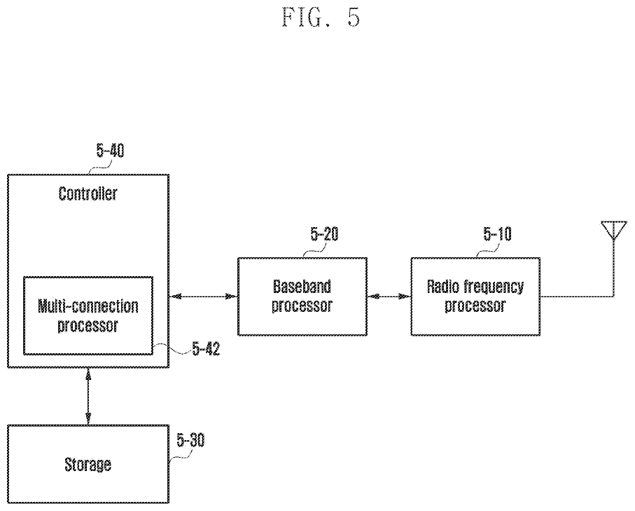

FIG. 5 illustrates a block diagram for an example of an internal structure of a UE according to an embodiment of the disclosure. The 1UE3 of FKi. 5 may be a UIE perforning sidelink communication. According to an embodiment, the UE may be a reference UE capable of transmitting a sidelink positioning reference signal (PRS) or a target UE that receives assistant data, which is configuration information for the SL-PRS, and reports a measurement result.

Referring to FIG. 5, the UE includes a radio frequency (RF) processing unit 5-10, a baseband processing unit 5-20, a storage unit 5-30, and a controller 5-40.

The RF processing unit 5-10 performs a function of transmitting and receiving a signal via a radio channel such as converting or amplifying a band of the signal. The RF processing unit 5-10 up-converts a baseband signal provided from the baseband processing unit 5-20 into an RE band signal, transmits the RF band signal via an antenna, and then down-converts the RF band signal received via the antenna into a baseband signal. For example, the RF processing unit 5-10 may include a transmission filter, a reception filter, an amplifier, a mixer, an oscillator, a digital-to-analog converter (DAC), an analog-to-digital converter (ADC), and the like. Although FIG. 5 illustrates only one antenna, the UE may include a plurality of antennas. The RF processing unit 5-10 may include a plurality of RF chains. Moreover, the RF processing unit 5-10 may perform beamforming. For the beamforming, the R^{F} processing unit 5-10 may control a phase and a size of each of the signals transmitted/received through a plurality of antennas or antenna elements. The RF processing unit may perform MIMO and receive a plurality oflayers when performing the MfMO operation.

The baseband processing unit 5-20 performs a function of performing conversion between a baseband signal and a bitstream according to a physical layer standard of the system. For example, in data transmission, the baseband processing unit 5-20 generates complex symbols by encoding and modulating a transmission bitstream. Further, in data reception, the baseband processing unit 5-20 reconstructs a reception bitstream by demodulating and decoding a baseband signal provided from the RF processing unit 5-10. For example, in an orthogonal frequency division multiplexing (OFDM) scheme, when data is transmitted, the baseband processing unit 5-20 generates complex symbols by encoding and modulating a transmission bitstream, mapping the complex symbols to subcarriers, and then configures FD) Im symbols via an Inverse Fast Fourier Transform (IFFT) operation and a Cyclic Prefix (CP) insertion. Further, in data reception, the baseband processing unit 5-20 divides the baseband signal provided from the RF processing unit 5-10 into units of OFDM symbols, reconstructs the signals mapped to the subcarriers via a Fast Fourier Transform (FFT) operation, and then reconstructs a reception bitstream via demodulation and decoding.

The baseband processing unit 5-20 and the RF processing unit 5-10 may transmit and receive the signal as described above. Accordingly, each of the baseband processing unit 5-20 and the RF processing unit 5-10 may be called a transmitter, a receiver, a transceiver, or a communication unit. Further, at least one of the baseband processing unit 5-20 and the RF processing unit 5-10 may include a plurality of communication modules to support a plurality of different radio access technologies. For example, the different radio access technologies may include a wireless LAN (e.g. IEEE 802.11), a cellular network (e.g. LTE), etc.. Further, the different frequency bands may include a super high frequency (ST) (e.g., 2.NRIHz, NRHz) band and a millimeter (mm) wave (e.g., 60 GHz) band.

The storage unit 5-30 stores data such as a basic program, an application, configuration information, and the like for the operation of the UE. In particular, the storage unit 5-30 may store information related to a second access node performing wireless communication using a second wireless access technology. The storage unit 5-30 provides stored data according to a request from the controller 5-40.

The controller 5-40 controls the overall operation of the UE. For example, the controller 5-40 transmits and receives signals through the baseband processing unit 5-20 and the RF processing unit 5-10. Further, the controller 5-40 records data in the storage unit 5-30 and reads the data. To this end, the controller 5-40 may include at least one processor. For example, the controller 5-40 may include a communication processor (CP) that performs a control for communication, and an application processor (AP) that controls an upper layer such as an application.

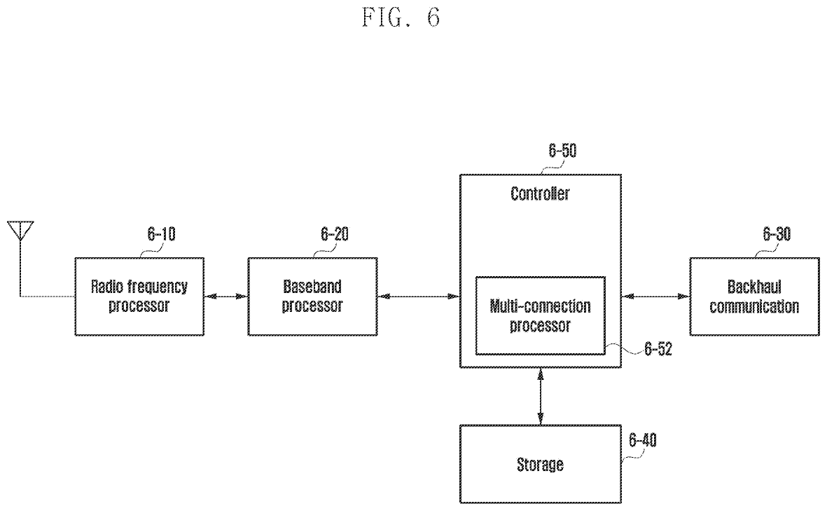

FIG. 6 illustrates a block diagram for an example configuration of an NR base station according to an embodiment of the disclosure.

As illustrated in FIG. 6, the base station includes an RF processing unit 6-10, a baseband processing unit 6-20, a backhaul communication unit 6-30, a storage unit 6-40, and a controller 6-50.

The RE processing unit 6-10 performs a function of transmitting and receiving a signal via a radio channel such as converting or amplifying a band of the signal. The RF processing unit 6-10 up-converts a baseband signal provided from the baseband processing unit 6-20 into an RF band signal and then transmits the converted signal through an antenna, and down-converts an RF band signal received through the antenna into a baseband signal. For example, the RF processing unit 6-10 may include a transmission filter, a reception filter, an amplifier, a mixer, an oscillator, a DAC, an ADC, and the like. Although FIG. 6 illustrates only one antenna, the first access node may include a plurality of antennas. In addition, the RF processing unit 6-10 may include a plurality of RF chains. Moreover, the RE processing unit 6-10 may perfonrm beamforming. For the beamforming, the RIF processing unit 6-10 may control the phase and the size of each of the signals transmitted and received through a plurality of antennas or antenna elements. The RF processing unit may perform a downlink MIMO operation by transmitting one or more layers.

The baseband processing unit 6-20 performs a function of performing conversion between a baseband signal and a bitstream according to a physical layer standard of the first radio access technology. For example, in data transmission, the baseband processing unit 6-20 generates complex symbols by encoding and modulating a transmission bitstrean. Further, in data reception, the baseband processing unit 6-20 reconstructs a reception bitstream by demodulating and decoding a baseband signal provided from the RF processing unit 6-10. For example, according to an OFDM scheme, in data transmission, the baseband processing unit 6-20 may generate complex symbols by encoding and modulatin^{g} the transmission bitstream, map the complex symbols to subcarriers, and then configure OFDM symbols via an IFFT operation and CP insertion. In addition, in data reception, the baseband processing unit 6-20 divides a baseband signal provided from the RF processing unit 6-10 into units of OFDM symbols, recovers signals mapped to the subcarriers through an FFT operation, and then reconstructs a reception bitstream via demodulation and decoding. The baseband processing unit 6-20 and the RF processing unit 6-10 may transmit and receive the signal as described above. Accordingly, each of the baseband processing unit 6-20 and the RIF processing unit 6-10 may be referred to as a transmitter, a receiver, a transceiver, a communication unit, or a wireless communication unit.

The backhaul communication unit 6-30 provides an interface for communicating with other nodes in the network. The backhaul communication unit 6-30 converts a bitstream to be transmitted from the main base station to the other node, for example, a secondary base station or a core network, into a physical signal and converts a physical signal received from the other node into a bitstream.

The storage unit 6-40 stores data such as a basic program, an application, configuration information, and the like for the operation of the main base station. Particularly, the storage unit 6-40 may store information on bearers allocated to the accessed U-E, a measurement result reported from the accessed U E, and the like. Further, the storage unit 6-40 may store information which is a reference for determining whether to provide or stop multiple connections to the UE. The storage unit 6-40 provides stored data according to a request from the controller 6-50.

The controller 6-50 controls the overall operation of the base station. For example, the controller 6-50 may transmit and receive a signal through the baseband processing unit 6-20 and the RF processing unit 6-10 or through the backhaul comnrnunication unit 6-30. Further, the controller 6-50 records data in the storage unit 6-40 and reads the data. To this end, the controller 6-50 may include at least one processor.

When positioning is performed via sidelink communication according to an embodiment of the disclosure, the positioning may be performed through the following procedures.

A target UE and a reference UE are UEs which may perform sidelink positioning together, and may discover each other by using a discovery message.

Discovery messages may be of the following types and may include different information:
discovery announcement for sidelink positioning (SL-P); and
a ProSe application code indicating the performance of sidelink positioning or reference UE service during sidelink positioning,
Alternately, apart from the ProSe application code, an indicator indicating the reference UE role of sidelink positioning may be included.
Required capability of a UE desired to be found may be expressed. For example, whether SL-P is performable or SL-PR_S transmission is performable may be indicated.

Discovery solicitation for SL-P:
may include a separate indicator or Prose query code indicating the performance of sidelink positioning or the target UE role of SL-P; and
may express the required capability of a UE desired to be found, and may indicate, for example, whether SL-P is performable or SL-PRS measurement is performable.

Discovery response for SL-P:
may include a separate indicator or ProSe response code indicating a response to a discovery message for the performance of SL-P or the reference UE role of SL-R

In discovery message model A, when the reference UE transmits a discovery announcement message, the target UE may receive the message. When the message includes the SL-P application code or the reference UE role indicator of the sidelink positioning service, and when the target UE wants to perform SL-P with the sending reference UE, the target UE may establish a PC5 unicast link with the reference UE.

In discovery message model B, when the target UE transmits a solicitation message, the reference UIE determines the content of the message and then performs response via a response message when desiring to perform SL-P.

The role of a sending UE in each message transmitted in the model A or B may be changed. In this case, each role-related indicator, ProSe application code, or ProSe response code may include the role of the sending UE according thereto, and then be transmitted.

The announcement message or the solicitation/response message may further include SL-P related capability information or preferred information. The relevant information may include:
supported or preferred SL-P method information and SL-PRS reception capability information in an announcement message transmitted by a reference UE may include;
supported or preferred SL-P method information and SL-PRS transmission capability information in an announcement message transmitted by a target UE;
in a solicitation message transmitted by a target UE, SL-P method information supported or preferred by itself and SL-PRS transmission capability information;
in a response message transmitted by a reference LE, SL-P method information supported or preferred by itself and SL-PRS reception capability information;
in a solicitation message transmitted by a reference UE, SL-P method information supported or preferred by itself and SL-PRS reception capability information: and
in a response message transmitted by a target UE, SL-P method information supported or preferred by itself and SL-PRS transmission capability information;

When the discovery messages include SL-P related capability information/preferred information, a discard or release procedure of the UE discovered via an additional SL-P related capability information procedure on PC5-link may be added after the corresponding discovery procedure.

One of the target device and the discovered reference device may establish a PC5 unicast connection.

PC5 unicast connection may be established via message transmission/reception on the general PC5-S protocol.

After establishment, the reference UIE and the target UE may transmit and receive messages regarding the following contents via the PC5 unicast connection. At this time, each message may use one of protocol architecture options 1 to 3 which are given separately.

Ranging request/response: When the role information of the sending UE having sent the message and/or the desired role information with respect to a counterpart UE and the SL-P capability information of the sending UE are included and transmitted, the receiving UE may accept a request to participate in SL-P (or ranging) when the sending UE wants the role performable by the sending UE.

The request message may include at least one of the following infornation:
as an SL-P or ranging factor, a ranging/SL-P role indicator indicating one of a reference UE or a target UE;
an indicator indicating whether ranging/SLP is one-time ranging/SL-P or periodic ranging/SL-P;
an indicator related to whether ranging/SL-P is for obtaining distance, is for obtaining direction, or for obtaining both;
preferred SL-PRS configuration information, supported positioning frequency layer, and supported or preferred SL-P method;
ranging/SL-P capability information and/or a message or indicator requesting SL-P/ranging capability information of the receiving UE; and
SL-PRS configuration information to be measured by the receiving UE for SL-P This information may be a target frequency, BWP, and resource pool for the sending UE of the message to sending SL-PRS, and/or may be target frequency, BWP, and resource pool information for the receiving UE of the message to receive and measure SL-PRS.

The request message may be a PC5-RRC message or a PC5-S message.

The response message may include the following information:
when the sending UE of the message wants to change the role requested in the request message, an indicator for the role desired by itself; and
preferred SL-PRS configuration information, which may include a positioning frequency layer or a preferred SL-P method.

When the received request message includes the SL-P capability information of the request message sending UE, the sending UE may determine whether the sending UE itself is able to respond to the information after viewing the information and indicate yes/no in the response message, and/or when the request message includes an indicator requesting capability information of the request message receiving UE, the response message may include SL-P/ranging related capability information of the corresponding response message sending UE.

When the request message includes SL-PRS configuration information transmitted by the request receiving UE, which corresponds to information requested by the request message sending UE, the response sending UE may indicate whether to allow the corresponding configuration information or not.

When the request message contains information in which the request message receiving UE requests measurement, the response message may include an indication indicating whether the receiving UE approves or disapproves the request.

When the request message contains information on whether it is one-time positioning or periodic positioning, it is for obtaining distance or direction or for obtaining both distance and direction, or information on preferred positioning method, the receiving UE may indicate yes/no for each requested item in a separate field, indicating whether the corresponding requested information is acceptable.

This message may be a PC5-RRC or PC5-S message.

When the UE that has sent/received the message desires to participate in ranging, the UE may transmit configuration information to its own AS layer, based on the SL-P related configuration information included in the message, and enable the AS layer to perform an SL-P operation, based on the corresponding configuration information.

As the SL-P operation, the UE determined as a sending UE transmits an SL-PRS. The UE determined as a receiving UE may receive and/or measure the transmitted SL-PRS and deliver a measurement result back to a network or the SL-PRS sending UE.

Capability request/response/announcerment: a message used to request capability information of each UE associated with SL-P, respond to the request, or transmit its own capability information.

The capability request message may include the following information:

Information on whether each SL-POS method (e.g., Sidelink-Observed Time Difference Of Arrival (SL-OTDOA), sidelik-Angle of Departure (SL-AoD), sidelink-time difference of arrival (SL-TDoA), sidelink-angle of arrival (SL-AoA), sidelink-Round Trip time (SL-RTT), etc.) is supported may be requested.

The capability response message may include the following information:

information on whether segmentation of SL-P related messages is supported; and

information on a supported method among the SL-POS methods.

The capability announcement message may include the following information:
Information on whether segmentation of SL-P related messages is supported and on a supported method among the SL-POS methods.
Request assistance data/providing assistance data: a message used to request or provide assistance data information related to SL-P
A providing assistance data message may include the following information:
At least one of the following information since the information is provided by a UE sending SL-PRS. The information may be information on frequency at which SL-PR_S is transmitted, absolute radio frequency channel number (ARFCN) or positioning frequency layer, BWP, resource pool information, or symbol level SL-PRS time/frequency location information.
When the UE which is supposed to measure the SL-PRS fails to receive the providing assistance data message, the request assistance data message may be delivered to the corresponding SL-PRS sending UE.
Request location information/providing location information:
a request location information message: sent by an SL-PRS sending UJE.

This is a message requesting a measurement target UE (reference UE) to perform measurement and report in a given format. The message may indicate a measurement method preferred by the SL-PRS sending UE and may include a report or position method configuration to be delivered. The report or position method may refer to a one-time measurement report or a periodic measurement report. The report or position method may also include an indication of whether the measurement is for distance, bearing, or both. The receiving UE receiving the indication may measure SL-PRS according to the method From the point of view of the UE that transmits the providing assistance data and the request location information message, the UE may start SL-PRS transmission before transmitting the request location information message or after transmitting the providing assistance data message;
providing location information: a message used when the UE that has measured the SL-PRS transmits the measurement result to the UE that requested the transmission of the measurement result. When the UE having performed the measurement knows its own relative position or absolute position information, the message may include the corresponding information and then be delivered. In this case, as the SL-PRS measurement result, not only the signal strength of the SL-PRS and the difference value according to the arrival time between transmission paths, but also relative or absolute location information of the SL-PRS sending UE may be delivered together in consideration of its own relative position or absolute position, based on the measurement result when requested by the request location information sending UE. This information may be transmitted as a separate message below; and
a location result sharing message: the message is information used to deliver a final positioning result value to the target UE or the UE having transmitted the SL-PRS, the reference UE combining a result value of the SL-PRS measured thereby with its own location information to obtain the final positioning result value.

When the messages are delivered onto PC5, the following protocol architecture may be used according to the message type.

Opt. 1. Use PC5-RRC layer

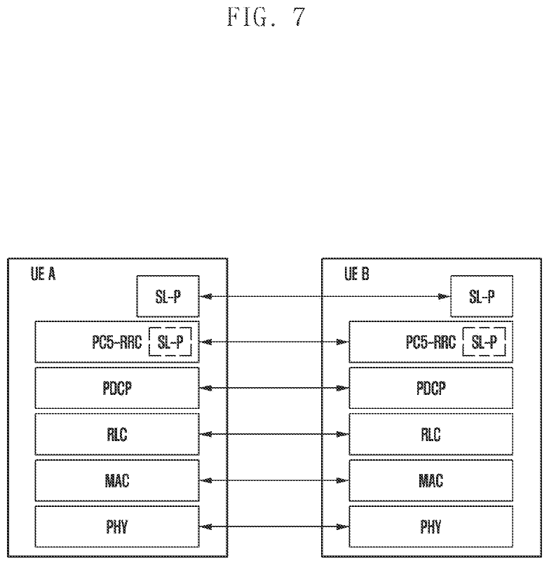

In the first example, a PC5-RRC layer may be used as shown in FIG. 7. When the PC5-RRC layer is used, PC5-RRC may be configured under SL-P. The SL-P message may be separately encoded or encapsulated in a specific PC5-RRC message, or included as pail of a field of the specific PC5-RRC message. Alternatively, a new PC5-RRC message may include SL-P message information. In each case, a peer UE may extract the encapsulated SL-P message from the received PC5-RRC message or receive the SLP message from the included field.

When using the PC5-RRC message, the SL-P message may be transmitted via SL-SRB3.

In another example, when a PC5-RRC protocol is used and a UE transmits an SL-P message, a separate dedicated SL-SRB may be established and transmission/reception may be performed via the corresponding SRB. For example, a PC5-RRC message including SL-P information may be transmitted/received via a separate SL-SRB (not SRB3) different from other PC5-RRC messages.

Opt. 2. Use PC5-S layer

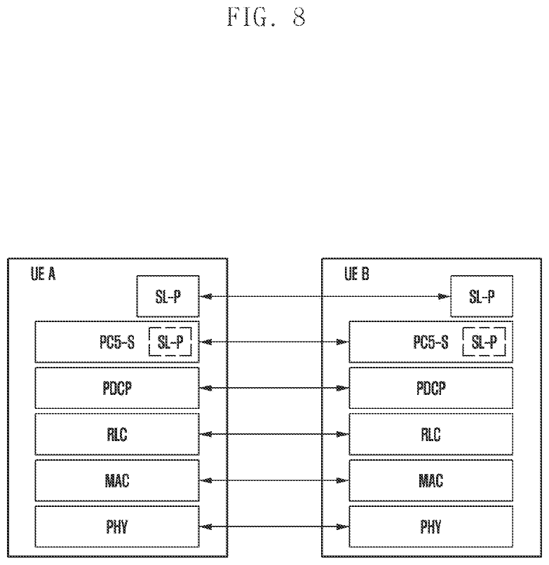

In the second example, a PC5-S layer may be used as shown in FIG. 8. When the PC5-S layer is used, a PC5-S or ProSe layer/entity may be utilized. SL-P messages/information may be encapsulated in a specific PC5-S message, or the specific PC5-S message may become an SL-P specific message. In each case, a peer UE may extract the encapsulated SL-P message from the received PC5-S message or receive the SL-P message from the included field.

When using PC5-S, transmission may be performed via SL-SRBO, 1, or 2 according to the progress of PC5-S security.

In another example, when a PC5-S protocol is used and a UE transmits an SL-P message, a separate dedicated SL-SRB may be established and transmission/reception may be performed via the corresponding SRB. For example, a PC5-S message including SL-P information may be transmitted/received via an SL-SR13 (e.g., an SR13 other than SRkB0,1,2) different from other PC5-S messages.

Opt. 3. Use discovery layer

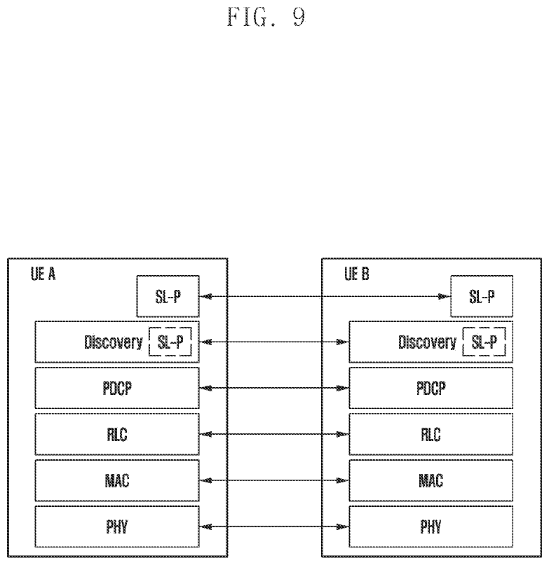

As a further example, a discovery layer may be used as shown in FIG. 9. In case of using the discovery layer, similarly, an SL-P message may be encapsulated inside the discovery message or an SL-P specific discovery message may be included therein.

When an SL-P message is transmitted in conjunction with the discovery message, PC5-RRC unicast link establishment may not be performed. In addition, discovery SL-SRB may be utilized.

As a discovery message for SL-P purpose, the following cases may be considered. An anchor Ut (reference Ut) may transmit a discovery solicitation message. The discovery solicitation message may be decoded/interpreted by a UE having an L2 destination ID value for discovery purpose, previously assigned to a plurality of peer UEs. The discovery solicitation message may include message type/information indicating that the UE is a reference UE for SL-P discovery or SL-P as a corresponding discovery message type. In addition, the discovery solicitation message may include the transmitted reference UE infornation, information on a target UE to be sought by the reference UE, and capabilities of the reference UE. The target UE may view and interpret the discovery solicitation message to conform to the SL-P discovery of the corresponding reference UE, and to view UE information or capability of the corresponding reference UE, and the target UE may determine to be discovered. When determination is completed, the target UE may also transmit a discovery solicitation response message as a discovery message for SLUP purposes. The discovery solicitation response message may be transmitted via unicast, groupcast, or broadcast. The discovery solicitation response message may include message type/information indicating that the UE is a target Ut for SL-P discovery or SL-P as a discovery message type. When the reference UE having received the discovery solicitation response message meets the capabilities of the corresponding target UE and meets the requested information of the reference UE, the reference UE may establish a PC5 direct unicast link with the target UE, and then transmit/receive PC5-RRC or PC5-S messages including SL-P information.

In another embodiment, as a discovery message for SL-P purpose, the tar_{g}et UE may transmit a discovery announce message. The discovery announce message may include message type/inforiation indicating that the UE is a target UE requesting SL-P. In addition, the discovery announce message may include target Ut information to be transmitted, reference UE information to be obtained, and capability information of the target UE. When the reference UE having received the discovery announce message meets the capabilities of the corresponding target UE and meets the requested information of the reference UE, the reference UE may establish a PC5 direct unicast link with the target UE, and then transmit/receive PC5-RRC or PC5-S messages including SL-P information.

As another embodiment, the reference UE may transmit a discovery announce message. Information which may be included in the discovery announce message by the reference UE may include information suitable for the purpose of the discovery message as described above. The target UE having received the discovery announce message may establish a PC5 direct unicast link with the reference UE when determining that the corresponding reference UE matches to itself, and then transmit/receive PC5-RRC or PC5-S messages including SL-P information.

As still another embodiment, the target HE may transmit a discovery solicitation message. Information which may be included in the discovery solicitation message by the target UE may information suitable for the purpose of the discovery message as described above. The reference UE having received the discovery solicitation message may transmit a discovery solicitation response message when determining that the corresponding target UE matches to itself. Information which may be included in the discovery solicitation response message by the reference UE may include information suitable for the purpose of the discovery message as described above. The target UE having received the discovery solicitation response message may establish a PC5 direct unicast link with the reference UE and then transmit/receive PC5-RRC or PC5-S messages including SL-P information

The above options may be selectively used according to the type of each message.

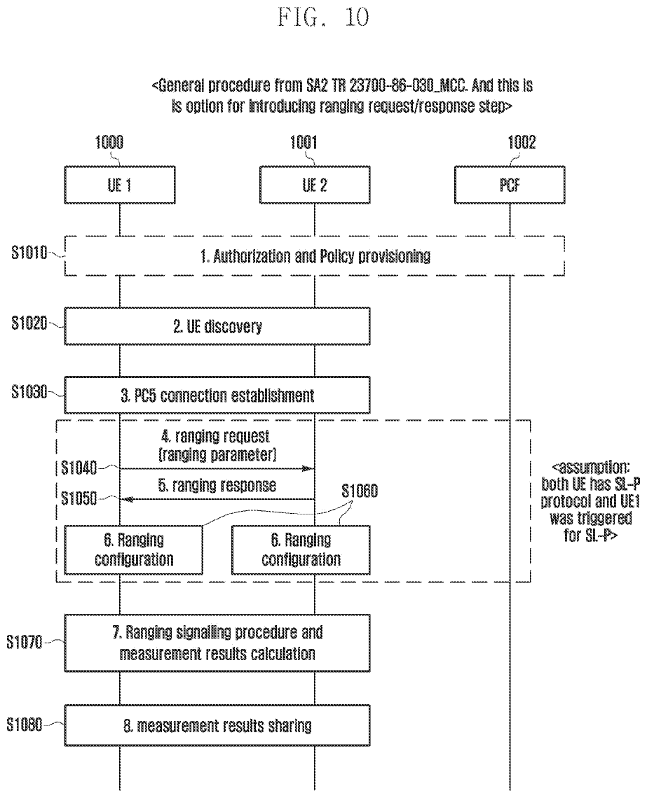

FIG. 10 illustrates a sequence diagram for an example of performing SL-P and ranging operation between UEs when a ranging request message and a response message are introduced, according to an embodiment of the disclosure.

A description of each message step in FIG. 10 is as follows.

In S1010, LE 1000, UE2 1001, and PCF 1002 may perform authentication and policy provisioning. (1. UE1 and UE2 may get the ranging authorization policy and parameters from PCF during the registration procedure. The ranging authorization policy and parameters may include whether the UE is authorized as Reference UE or Target UE.) In the embodiment in FIG. 10, the LE1 1000 may be a reference UE, and the UE2 1001 may be a target UE.

In S1020, the UE1 1000 and UE2 1001 may perform UE discovery. (2.

When the UE1 gets the ranging request from the application layer, another UE, or 5GC NF, UE1 can discover UIE2 by using the solutions for KI #3 Ranging/Sidelink Positioning device discovery.)

In S1030, the UE1 1000 and JE2 1001 may perform PC5 connection establishment. ((3. LE1 and UE2 can perform the PC5 connection establishment, as defined in TS 23304 [4].

NOUE: PC5 connection is established for the signalling interaction of ranging parameters between two UEs. This step may be optionally used when Ranging/Sidelink positioning is between two UEs.)

In S1040, the Ul 1000 may transmit a ranging request message including ranging parameters to the UE2 1001. (4. UE1 sends the ranging request to the UE2 to negotiate the ranging parameters, and the ranging request can be a new PC5-S signalling carried by the PC5 connection. The ranging request includes the ranging parameters, e.g. the Ranging role (Reference UE or Target UE), one time or period ranging, and ranging for distance or direction measurement or both. Ranging parameter also can include the preferred SL-PRS configuration such as supported positioning frequency layer, and/or supported/preferred SL-P method. SL-P capability information (or SL-P capability request message/indication) also can be transferred in this message.

Moreover, this request message can include the SL-PRS configuration information in which UE 2 measures for positioning. SL-PRS configuration information can include frequency, BWP and resource Pool for SL-PRS in which UE will transmit SL-PRS, and/or frequency, BWP and resource pool in which UJE2 will receive and measure the SL-PRS for positioning. This information also can be ones in step 7-1 SL-P capability information of UE1 and SL-P Assistance Data in step 7-2.

Moreover, this request message can include measurement request indication to UE2 with information on preferred method and reporting configuration regarding one time measure/report or periodic measure/report, and metric for direction or distance or both to UE2 as in step 7-3.

U-E 1 can determine the Ranging role based on the ranging authorization in step 1 or ranging capability (capability as Reference UE or Target UE). For example, the UE1 decides to act as Reference UE, then the Ranging role means that “1 am Reference UE” or “you are Target UE”.

UE1 can get the one time or period ranging, ranging for distance or direction measurement or both from the application layer when the application layer sends the ranging request to the upper layer (e.g. Ranging layer).

This ranging request message can be carried within a PC5-RRC message or a PC5-S message.)

In S1050, the UE2 1001 may transmit a ranging response message to the UE 1000. (5. UE2 sends the ranging response to the UEL If UE2 wants to change the Ranging role (e.g. UE2 wants to act as Reference UE), for example due to its ranging capability, a new Ranging role is included. Once UE2 has a preferred SL-PRS configuration, such as Positioning frequency layer (PFL) or the SL-P method, UE2 can also include that information in the message. If SL-P capability infornation is included in step 4, UE32 can check whether that capability is matching or not. Alternatively, if a SL-P capability request message/indication is received in step 4, UE2 can respond by including SL-P capability of UE2.

If UE2 receives SL-PRS configuration information from UE 1 in step 4, UE2 can respond to accept that SL-PRS or not.

If UE2 receives measurement request from U1E 1 in step 4, U^{J}1E2 can respond to accept or not to accept.

This ranging response message can be carried within a PC5-RRC message or a PC5-S nessage.)

In S1060, each of the UE 1 1000 and the UE2 1001 may configure ranging. (6. The upper layer of each UE (e.g., the UE1 and UE2) provides the ranging configuration to the AS layer. The ranging configuration includes the ranging role (e.g., whether each UE is a reference UE or a target UE), one time or period ranging, and ranging for distance or direction measurement or both.)

In S1070, the UE 1000 and the UE2 1001 may perform a ranging signaling procedure and calculate a measurement result. (7. The AS layer of each UE transmits or receives ranging signalling according to the ranging configuration, and the Reference UE calculates the ranging results. For example, for direction measurement, Target UE transmits Ranging signalling and Reference UE receives it accordingly.)

7-1. UE1 or reference UE can transmit SL-P capability information request message to UE2 or target UE. Then UE2 or target UE can respond to transmits SL-P capability information. This SL-P capability information can be carried within PC5-RRC or IPC5-S message. This step can be omitted if step 4 has capability information transaction.

7-2. UE 1 or reference UE can transmit SL-P AssistanceData which includes the SL-PRS configuration to be measured by UE2 or the target UE including Pill, symbol level resource, and frequency and time information which will be transmitted by UE 1. If UE 2 or target UE receives this message it store this information for measurement. If there is no AssistanceData, UE2 or the target UE can request AssistanceData to UE1 This AssistanceData and AssistanceData request message can be carried within PC5-RRC/PC5-S message.

7-3 UE1 can transmit a measurement request to UE2 with information on a preferred method and reporting configuration regarding one time measure or periodic measure and report, and measurement metric for direction or distance or both. UE 2 can further respond to this message.

7-4 UE1 transmits SL-PRS based on configuration in step 7-2. Then UE1 can transmit an SL-PRS measurement request including a preferred method and reporting configuration such as the reporting configuration including periodic or one time reporting. UE2 can measure the SL-PRS, and if UE2 can fulfill the required QoS of the measurement, UE2 can report the result including measurement values for the indicated method (display a result value for each case) based on reporting configuration. For example, if distance is required, then SL-P method requiring RSRP measurement can be configured for SL-P method, or if direction is required, then SL-P method such as UL/DL-AOD or AoA method can be configured. This measurement request and its report message can be carried within the PC5-RRC/PC5-S message.

7-5. If the step 4 and 5 messages are included SL-PRS configuration information, there might be no 7-1 and 7-2 steps above. If step 4 and 5 messages are included measurement request and its response, there might be no step 7-3.)

In SI080, the UE1 1000 and the UiE2 1001 may share measurement results. (8. The ranging results could be shared between the UEs via the PC5-S signalling, for example.

8-1. UE1 can find the location based on measurement result, and this location information can be transmitted to the UE2. This mnessage can be carried within the PC5-RRC/PC5-S message.)

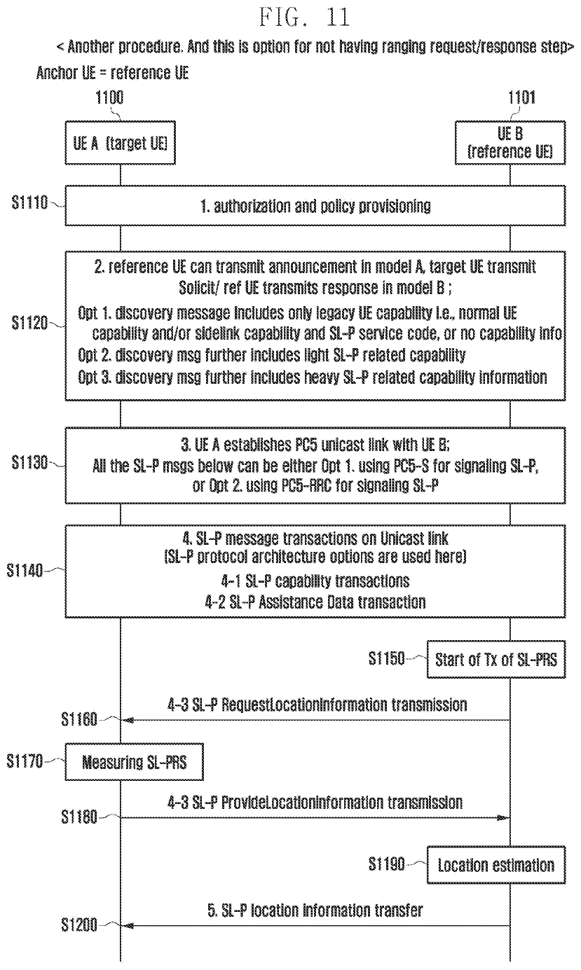

FIG. 11 illustrates a sequence diagram for an example of exchanging SL-P purpose-specific messages between UiEs without a ranging request/response message after a unicast link is established, according to an embodiment of the disclosure.

The description of each step is as follows.

In S1110, the UE A (a target UE) 1100 and the UE B (a reference UE) 1101 may perform authentication and policy provisioning. (1. The tE A and the tE B may get the ranging authorization policy and parameters from PCF during the registration procedure. The ranging authorization policy and parameters may include whether the UE is authorized as a reference UE or a target UE. According to an embodiment, it is assumed that the UE A is a target UE and the UE B is a reference UE.)

In S1120, the reference UE 1101 may transmit a discovery announcement message in model A. In addition, the target UE 1100 transmits a discovery solicit message in model B, and the reference UE receiving the discovery solicit message ma_{y} transmit a discovery response message. (2. When the UJE A gets the ranging request from the application layer, other UE, or 5GC NF, UE A can discover UE B by Ranging/Sidelink Positioning device discovery.

2-1. When a request is from an application, the layer triggers SL-POS service with an indication to SL-P layer of role, one time/periodic ranging, and distance or direction or both, Positioning discovery method.

2-2. There could be two options in discovery in terms of which information can be included in the discovery transaction.

Opt 1. Discovery message carries the restricted information for discovery such as Type of Discovery Message, Ranging/Sidelink Positioning service Code, and Target UE capability (e.g. ranging support) in model A announce message OR the Solicitation message (reference UE to target UE) in model B may include the Type of Discovery Message, and Ranging/Sidelink Positioning service Code, in a response message (target UE to reference UE) In this case, SL-P related capability should be communicated after PC5 unicast link establishment. Furthermore, the UE not fulfilling the SL-P capability would be dropped, i.e., released by target UE after unicast link establishment.

Opt 2. light SL-P related capability: target UE infornation/reference UE information, Role indication, target UE/reference UE. SL-P service availability, SL-P method supported, capability on Tx SL-PRS, cap on Rx SL-PRS. In this case, further SL-P related heavy capability should be communicated after PC5 unicast link establishment. A UE not fulfilling then would be dropped/released after unicast link establishment.

Opt 3. A discovery message further carries heavy SL-P related capability to find the UE fulfilling those capabilities, such as SL-POS capability including the SL-POS resource preference infornation, positioning reference unit (PRIJ)/road side unit (RSU) capability/feature indication, per SL-P method, supported frequency band. In this case, there is no case to establish a unicast link with a UE not fulfilling the SL-P capability requirement.)

In S1130, the UE A 1100 may establish a PC5 unicast link with the UE B 1101. At this time, all of the following SL-P messages may be transmitted using PC5-S in option 1 for SL-P signaling, or may be transmitted using PC5-RRC in option 2 for SL-P signaling. (3. UE A or UE B can transmit UECapabilityEnquirySidelink to UIE B or DIE A, respectively. In this message, SL-P capability enquiry request indication can be included. The response message of UECapabilitylnformationSidelink can be transmitted by the receiver UE including SL-P capability information. In this case, step 4-1 may be optional.)

In S1140, the SL-P message may be processed on the unicast link. (SL-P protocol architecture options may be used here.) In addition, SLP capability may be processed, and SL-P assistance data may be processed.

4-1 SL-P capability transaction: UE B (1101) requests SL-P capability information to UE A (1100) when option 1 and/or option 2 in step2 was used. If option 3 is used, then the remaining heavy SL-P capability information is requested/responded.

After 4-1, the instigator of this discovery transaction or capability request msg can drop or release the other UE when the instigator cannot fulfill the required capability of SL-P

4-2 reference UE (UE B)(1101) determines its SL-PRS resource TX pool, and sends within AD to target UE (Ut A)(1100) the information of the SL-PRS resource to be measured, and measurement configuration information(i.e., report configuration, one time/periodic measurement, one time report/periodic report etc.)

If UE A(target UE)(1100) responds positively to this AD, UE B (reference UE)(1101) can go to 4-3. UE B(reference UE)(1101) can start the transmission of SL-PR_S for positioning with UE A (target UE)(1100)

In S1150, the UE B (the reference UE) 1101 may initiate transmission of the SL-PRS. In 81160, the UE B (the reference UE) 1101 may transmit RequestLocationInformation to the UE A (the target Ut) 1100.

In S1170, the UE A (target UE) 1100 may measure SL-PRS. In S1180, the UE A (the target UE) 1100 may transmit ProvideLocationInformation to the UE B (the reference UE) 1101. (4-3. UE B(reference UE)(1101) can transmit SL-P message including request for the measurement of SL-PRS to UE A(target UE)(1100) for the given SL-PRS resource (pool) configuration and request for reporting the measure result to UE B(reference UE)(1101). If the report configuration indicates one time report, step 4-3 includes one time transmission of a ProvideLocationlnformation msg. If the report configuration indicates periodic measurement/report, then step 4-3 can repeat the measurement, and reporting of that measurement result.)

In S1190, the UE B (the reference UE) 1101 may perform location estimation. In S1200, the UE 13 (the reference UE) 1101 may transmit SL-P location information to the UE A (target UE) 1100. (5. reference UE can transfer the estimated location based on its own location information and the received measurement result from the target UE)

In the disclosure, SL-P may refer to sidelink positioning, and ranging may refer to distance/direction measurement. SL-P and ranging may indicate SL-P or ranging, or both rather than indicating either one or any one alone, even if not explicitly indicated.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular forin or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first terminal in a sidelink communication system, the method comprising:
transmitting a discovery message for a sidelink positioning including a proximity services (ProSe) application code indicating the sidelink positioning;
establishing a link for the sidelink positioning with a second terminal;
transmitting, to the second terminal, a sidelink positioning assistance data including sidelink positioning reference signal (PRS) configuration information;
transmitting, to the second terminal, at least one PRS based on the PRS configuration information; and
receiving, from the second terminal, a measurement result for the at least one PRS.

2. The method of claim 1, further comprising:
determining positioning information based on the received measurement result; and
transmitting, to the second terminal, the determined positioning information.

3. The method of claim 1, further comprising:
transmitting, to the second terminal, a ranging request message including at least one ranging parameter; and
receiving, from the second terminal, a ranging response message in response to the ranging request message.

4. The method of claim 3, wherein the at least one ranging parameter includes at least one of a supported positioning frequency layer, a preferred sidelink positioning method, or sidelink positioning capability information, and
wherein the ranging response message includes information on whether the at least one ranging parameter included in the ranging request message is accepted by the second terminal.

5. The method of claim 1, wherein transmitting the sidelink positioning assistance data further comprises:
determining a sidelink PRS resource for measuring,
wherein the PRS configuration information further includes at least one of the determined sidelink PRS resource, measurement period information, or report period information.

6. A method performed by a second terminal in a sidelink communication system, the method comprising:
receiving a discovery message for a sidelink positioning including a proximity services (ProSe) application code indicating the sidelink positioning;
establishing a link for the sidelink positioning with a first terminal;
receiving, from the first terminal, sidelink positioning assistance data including sidelink positioning reference signal (PRS) configuration information;
receiving, from the first terminal, at least one PRS based on the PRS configuration information;
measuring the at least one PRS; and
transmitting, to the first terminal, a measurement result for the at least one PRS.

7. The method of claim 6, further comprising:
receiving, from the second terminal, positioning information which is determined by the second terminal based on the measurement result.

8. The method of claim 6, further comprising:
receiving, from the first terminal, a ranging request message including at least one ranging parameter; and
transmitting, to the first terminal, a ranging response message in response to the ranging request message.

9. The method of claim 8, wherein the at least one ranging parameter includes at least one of a supported positioning frequency layer, a preferred sidelink positioning method, or sidelink positioning capability information, and
wherein the ranging response message includes information on whether the at least one ranging parameter included in the ranging request message is accepted by the second terminal.

10. The method of claim 6, wherein a sidelink PRS resource for measuring is determined by the first terminal, and
wherein the PRS configuration information further includes at least one of the determined sidelink PRS resource, measurement period information, or report period information.

11. A first terminal in a sidelink communication system, the first terminal comprising:
a transceiver; and
at least one processor configured to:
transmit, via the transceiver, a discovery message for a sidelink positioning including a proximity services (ProSe) application code indicating the sidelink positioning;
establish a link for the sidelink positioning with a second terminal;
transmit, to the second terminal via the transceiver, a sidelink positioning assistance data including sidelink positioning reference signal (PRS) configuration information:
transmit, to the second terminal via the transceiver, at least one PRS based on the PRS configuration information; and
receive, from the second terminal via the transceiver, a measurement result for the at least one PRS.

12. The first terminal of claim 11, wherein the at least one processor is further configured to:
determine positioning information based on the received measurement result; and
transmit, to the second terminal via the transceiver, the determined positioning information.

13. The first terminal of claim 11, wherein the at least one processor is further configured to:
transmit, to the second terminal via the transceiver, a ranging request message including at least one ranging parameter; and
receive, from the second terminal via the transceiver, a ranging response message in response to the ranging request message.

14. The first terminal of claim 13, wherein the at least one ranging parameter includes at least one of a supported positioning frequency layer, a preferred sidelink positioning method, or sidelink positioning capability information, and
wherein the ranging response message includes information on whether the at least one ranging parameter included in the ranging request message is accepted by the second terminal.

15. The first terminal of claim 11, wherein the at least one processor is further configured to:
determine a sidelink PRS resource for measuring,
wherein the PRS configuration information further includes at least one of the determined sidelink PRS resource, measurement period information, or report period information.

16. A second terminal in a sidelink communication system, the second terminal comprising:
a transceiver; and
at least one processor configured to:
receive a discovery message for a sidelink positioning including a proximity services (ProSe) application code indicating the sidelink positioning;
establish a link for the sidelink positioning with a first terminal;
receive, from the first terminal via the transceiver, a sidelink positioning assistance data including sidelink positioning reference signal (PRS) configuration information;
receive, from the first terminal via the transceiver, at least one PRS based on the PRS configuration information;
measure the at least one PRS; and
transmit, to the first terminal via the transceiver, a measurement result for the at least one PRS.

17. The second terminal of claim 16, wherein the at least one processor is further configured to:
receive, from the second terminal via the transceiver, positioning information which is determined by the second terminal based on the measurement result.

18. The second terminal of claim 16, wherein the at least one processor is further configured to:
receive, from the first terminal via the transceiver, a ranging request message including at least one ranging parameter; and
transmit, to the first terminal via the transceiver, a ranging response message in response to the ranging request message.

19. The second terminal of claim 18, wherein the at least one ranging parameter includes at least one of a supported positioning frequency layer, a preferred sidelink positioning method, or sidelink positioning capability information, and
wherein the ranging response message includes information on whether the at least one ranging parameter included in the ranging request message is accepted by the second terminal.

20. The second terminal of claim 16, wherein a sidelink PRS resource for measuring is determined by the first terminal,
wherein the PRS configuration information further includes at least one of the determined sidelink PRS resource, measurement period information, or report period information.
